(19) United States
(12) Patent Application Publication
(10) Pub. No.: US 2019/0260840 A1
(43) Pub. Date: Aug. 22, 2019

(54) METHOD AND SYSTEM FOR TRANSFORMING AND INTEGRATING MOBILE DEVICE SHOPPING INTERFACES ACROSS MULTIPLE SHOPPING VENUES AND CARRIERS

(71) Applicant: MINIME LABS, INC., Austin, TX (US)

(72) Inventor: Constantinos Demetriou, Limassol (CY)

(21) Appl. No.: 16/281,236

(22) Filed: Feb. 21, 2019

Related U.S. Application Data
(60) Provisional application No. 62/633,509, filed on Feb. 21, 2018.

(51) Int. Cl. H04L 29/08; G06Q 50/30; G06Q 50/14

(52) U.S. Cl. CPC H04L 67/18; H04L 67/22; G06Q 50/14; G06Q 50/30

(57) ABSTRACT

The present disclosure relates to methods and systems for providing a location-based, single user-centric application for all customer experienced application data will be built as a transformative application, offering adaptive content, based on location, vendor, personal data and cross channel information. The aim is to move away from a narrow-focused application into a personalized application that will offer increased functionality offering targeted, incremental, timed communication with the user and/or application. This will be based on intelligence of the application that keeps learning from big data that is scaled into focused data. The big data will be gathered from implicit, explicit as well as location and environment data feeds related to pre-action, action and post action from the user. These can also include subconscious actions while using the application.

### FIELD OF THE INVENTION

The present disclosure relates to methods and systems for providing a location-based, single user-centric application for all customer experienced application data will be built as a transformative application, offering adaptive content, based on location, vendor, personal data and cross channel information. The aim is to move away from a narrow-focused application into a personalized application that will offer increased functionality offering targeted, incremental, timed communication with the user and/or application. This will be based on intelligence of the application that keeps learning from big data that is scaled into focused data. The big data will be gathered from implicit, explicit as well as location and environment data feeds related to pre-action, action and post action from the user. These can also include subconscious actions while using the application.

### PRESENTATION OF INVENTIVE SUBJECT MATTER

A recent study by Aaron Agius from Louder Online, indicated that 94% of companies claim that personalization is a key component of their success. Meanwhile, 56% of consumers would happily purchase from a company that provides a good—not even great—personalized experience. Goefencing technology has also been used by various businesses offering pricing or sales notification, but not taking data or security challenges always into consideration. More ever, the approach till now was targeting specific areas of interest, narrowing focusing the output to any user within the geofence.

According to TechTarget, “Location is a vital dimension of the Internet of Things concept that encompasses the ability of ‘things’ to sense and communicate their geographic position. In this context, location acts as an organizing principle for anything connected to the Internet.

The Flying Plaza Transformer App aims to solve the common problem of customers having to download different custom apps to perform “specific but the same” functions depending on the vendor. The problem extends to the downloaded app being general with little or no personal affiliation to the client, thus resulting in no longevity and continuity use after the travel itinerary has been completed.

The Flying Plaza Transformer App aims to offers a unique customer service experience that will result in a single download of a default app that will change and transform into the participating vendor's ‘app’. The transformer app aims to act as an interactive assistant, using AI to learn the cognitive behavior of the client, with every ‘assisting’ action.

The transformer application will be built on a layered technology stack that connects vendors/content providers through modules to create a data collection, analytical platform that incorporates the BI and Machine Learning parts of the innovation. The Personalized IQ module provides:
Personalized Data
Location based Data
Vendor based Data
Adaptive Data

Personalized data will be provided based on implicit/explicit data collection, collected during login and preference settings. This data together with historical user data will be used to create a user centric set of data that will help in profiling the user in pre-action (for exampling searching or viewing items without purchasing) and after (e.g. xxxxxxxxxx). This historical data will be used in return to create the user journey that will be accessible via a map for the use case of a shopping mall, allowing the user to revisit the retailers and communicate with them.

Location based Data will be made possible because of the usage of different technologies. Geofence data will be divided into two different types of location based information. The first is location based data according to position with a roaming attempted provisioning of data. Position can be supplied by means of one of the following:

1. Media Server (Airbox) that provides specific preloaded content if the user is within the geofencing area of the specific vendor using the Airbox.

2. Assistant GPS (geolocation) sent from phone location services

3. IP Addressing will be used to provide vendor adaptive information throughnatted single IP address of the specific vendor.

4. DNS routing map can be used from the vendor configured specification table.

Vendor based data that will be modularly supplied according to the unique transformative capability. Initially the user will install the transformer application from any of the content providers/vendors. This provider, from where the user installed the application, will be the default provider that the app will revert to in the case of no location based provider can be established. If during the location based beaconing process, a new content provider is found, the app will transform and load the new data. In the case of a mall with multiple vendors a parent/child relationship will exist in terms of the first download will get the branding and content of the provider the app was download from. Once in the radius of another retailer a seamless UX will hand over to the ‘new’ retailer making the app adapt, taking on the adopted (child) providers branding and content.

Adaptive data will be provided as one of the following content types:

Reusable Content—Content that can be used on different platforms from mobile, virtual or wearable devices.

Structured Content—Content that are constant in position and structure throughout the user journey, yet adaptive in context.

Presentation-Independent Content—these include notifications that can be both direct or indirect, in different formats either via message boxes, chat, feedback, prompts, announcements etc.

Meaningful Metadata—This hidden data describes the purpose and intent of the content. This will assist the machine learning in the development of the personalized IQ as to enhance the display not just of location based associated data, but also user centric data.

Most applications offer communication that are based on direct communication, this type of communication can be done via chat (life or via bots), feedback provisions or contact us session. Search can also be classified as a type of communication. Most search results will not have a targeted output. The innovative companion to the transformative application will offer a full two-way communication, using both direct and indirect communication. This means that the results from a search will offer a targeted search results, that will have the results based on the personalized IQ of the specific user. Communication can be initiated from the customer to the vendor/retailer, but can also be initiated from the vendor/retailer through notifications that include incremental timed offers, suggested communication based on the transformative application intelligence based on the user journey and the personalized IQ.. The location based technology used in the application will also in addition make use of the one of the following three technologies to offer additional communication based on the user specific position at a vendor. These includes: BLE beacons, WIFI and GPS. Bluetooth low energy will work n tandem with the transformative application I order to:

Trigger a push notification when a user is in a certain distance from a product, has shown interest for a time period predefined, has been showing interest in that specific brand etc

Trigger a push notification towards the retailer for possible interaction suggestion with the client

Update the user data regarding time spend, product category, user journey etc.

The reason Bluetooth low energy beacons will be used is the high accuracy and the ability to offer context aware messaging, but in the case of the transformative application, also user centered.

Today, custom Internet advertising is widespread, according to a 2014 Pew Internet and American Life Project report, 59 percent of Internet users said they observed targeted advertising while surfing the Web according to Purcell, Brenner, and Rainie. These are usually tied to location-based mobile advertising that are tied to GPS technology that can capture offline consumer activity. Having an understanding of not only online user activity, but also offline, real-world consumer behavior, a more precise identity and profile can be created that will allow the vendor to provide targeted one-to-one offers or information to the customer.

Bu using hyper-local targeting, GPS technology can also be used to offer targeted content, based on any pre-defined radius around any location. This content can be divided into two different types: by choice or automated

Context awareness is a key factor in pervasive and targeted mobile advertising.

Most targeted advertising are based on user searches and online buying behaviour. The ability to offer insights on a continuous user journey for both online and offline behavior is of essence as to be able to offer advertising based on more than previously bough items, complimentary items or related items.

The other issue faced by retailers/vendors is the need of understanding customer data. Although ⅓ of retailers indicate that they have enough data from customers, big data needs to become focused data. One of the issues faced by retailers is that data can be interesting, but to determine if the data is valuable is a process that needs to be introduced in order to offer contextual and proper targeted advertising.

The platform for targeted advertising that will be offered, will have a two-way interface. The one will allow the vendor to filter through profiles for timed, contextual and targeted advertising at a one -to—one base. The other interface will allow the client application to request cross-channel, location based, personalized marketing material that are user centric and orientated.

The contextual data will be organized according to a unique Context Measurement Ontology that will provide a model of hierarchical and multi-dimensional context-models. The basic elements will include time, space, interest-topic, user unique profile as created via machine learning and cognitive behavior.

This type of advertising and/or information falls in the research area of computational advertising that is concerned with problems and solutions in automated advertising. The main areas that the suggested innovation will target will be: (i) contextual advertising, i.e., advertisements on the basis of the interests and the activities of the user, (ii) previously or current searched, i.e., delivering advertisements on the basis of user queries on a search engine, (iii) behavioral targeting, i.e., exploiting data collected from both online and off-line behavior of the user to target the advertisements and, (iv) Intelligent systems, i.e., recommending products or services by comparing the user profiles and behaviors.

Overall the mobile application will be triggered, either synchronous or asynchronous, to scan the nearby networks for minime labs enabled partners and will perform the following steps: 1. scan of the available hotspots, 2. connection to the hotspot's network, 3. download of the available pervasive adverts/information and context-inference, and 4. retrieval and download of all media.

Personalized data display: The ability to render personalized, adaptive, relevant data has been a primary focus in bettering customer effective and orientated service as an application for the past decade.

According to the Quarterly Digital Intelligence and Trends (2015), personalization and relevance of data offered are the highest focus for client-side marketers, Consistency across channels are at number 3. A full list of the six major factors to consider for innovative, targeted personalized, location based data, was done under retailers in February 2015 by FIFO commerce. The top challenges that were identified: ability to dynamically create personalized content, data limitations, concern about data privacy, design workload and UX. More ever in the same report it is indicated that only a third of brands reported they have enough usable consumer data, the other third did not have enough data and the rest did not know how to action the data they did have.

To offer customer-centric retailing, focusing on having a personalized IQ, by practicing the use of data driven customer insights to improve product assortment promotion planning, pricing and marketing personalization. Although mainly the focus is from the retailer to sell the data to the brands, in order to obtain personalized initiatives, Flying Plaza aims to offer 1-1 personalized capabilities on demand, this will allow for incremental timed and highly customized options for targeted offers,

Through this the customer will receive

1. Personalized, adaptive advertising

2. TPR (temporary price reduction) hybrid pricing strategy

3. Relevant offers

Data capturing disincentivizing signup, cognitive behavior according to Forester 2014 collecting of data, both implicit and explicit have to be limited. Data capturing and analyses should continue through customization or machine learning after the app is installed and used.

Account customization of which more than 94% of apps cater for provides data capturing in context, high quality relevant offers based as reciprocity for providing additional information

A world-wide study under millenniums by SDL (2014) indicated that:

49% was in favor of receiving recommendations

44% would give me information if targeted

44% no issue if data is used to improve experience

46% did not like the use of personal data for targeted offers

47% not in favor if companies know what you want before you know you want it

Most recommendation are based on similar products (71%), Complimentary (56%) and recently viewed (36%).

Cross-channel personalization according to Mybuys 2014 are favored by 56% retailers and 52% consumers, with only 7% of retailers having this technology.

Every channel, context, module of information and scenario should serve in making the consumer journey unique and personalized. The aim of any platform providing content marketing should form part of a development and implementation of a comprehensive content strategy. This strategy should provide enough insight into the mind of the customer in order to offer a clear direction for personalization and adaptive content. The strategical approach for personalized location based content will be based on 4 layers.

1. Create Personalized IQ: Create complex, situational overviews of their needs, goals, challenges and pain points. Current buying behavior, reference points, interests, mood analysis, devices, brand preference, product type, price, discount, weather, time, date.

Group-Using information to develop specific IQ for each user based on location, vendor and content through intelligence defined through machine learning.

Create Personalized Context: Personalized content that will be based on the in-depth personas created via the personalized IQ, that will offer functions, features and content based on user profile. The main aim of this is to nurture the relationship with the consumer in a strategic focused way, providing content that are timed according to location, profile and user goals.

Offer Adaptive Characteristics: By its very nature, adaptive content must adapt. That means, it needs to change based on certain characteristics of the individual user. This will allow the creations of a user ambience.

This adaptive content should be based on physical location, date or time of day, which channel providing the transformative content, purchase history, buying cycle and any other subconscious micro-conversions. These adaptive set of information can further be triggers by business rules defined by the content providers and/or vendors through an advertising platform that is part of the unique service included in the transformer application capabilities.

Presentation of content: Ensuring that content is displayed dynamically, seamlessly and intelligent. The display will be scalable and device agnostic and will be able to be adjusted from mobile to virtual reality, wearable devices and voice assistance.

Functionality-The below explains each item that needs to be part of the functionality of the app.

Android Native (Java) App

a. Will produce an app capable of running on Android 5.0.1 and above, including Android 8 Oreo

b. Will be capable of running on legacy devices, but will guarantee smooth performance on devices with more than 1.5 GB of RAM

c. App will feature pull to refresh on screens that pull data from the online sources

d. Will feature a splash screen and an app logo, that remains unchanged

e. Scalable system with powerful back-end framework

f. Adapts to smartphones

g. Adapts to tablets

Transformer Capabilities

a. Works when identified a vendor (store, airport, flight) via geolocation and geofencing

b. Works when identified an AirBox and delivers specific data as per AirBox repository

c. Works when manually tracing the store by changing current location

d. Transforms app UI (logo, app bar, navigation bar, menu drawers, background colors, framing and border colors, primary text color, secondary text colors, primary and secondary theme colors)

e. Transforms styles according to fixed brand guide per vendor

f. Can dynamically add new vendor styles in web admin (no need to rebuild app to add new vendors, can be done on the fly)

g. Does not change app splash screen or app logo icon

h. Does not change app name

i. Retains all UX (does not change user experience, just look and feel)

Geolocation and Geofencing

a. Allows a vendor to be identified by longitude, latitude and a radius for range

b. Does not utilize altitude (not precise)

c. Uses phone's geolocation information, with sensors, gyros, accelerometer and assisted GPS through WiFi

d. Identifies loss of connection and retains location to last known

e. Allows manual override of location

f. Allows automatic location detection (default)

g. Requests consent from user

h. Accommodates for overlap by reducing flapping using hold-downs (does not switch back and forth from a vendor if you're on the borderline of more than 1 vendor)

i. Via the web admin portal, these vendors can be set with their geofencing parameters

Automatic Vendor Recognition

a. Provides a 1-way recognition system
1. Attempts to identify via user automatic location or manual location with geofencing data

b. Changes entire system to request data from subdomain specific URLs (i.e. walmart01.flyingplaza.com or cobalt14.flyingplaza.com) based on identified vendor

c. Is dependent on multi-vendor backend to provide the content based on the requested subdomain

d. Has a default subdomain based on the first identified vendor when installed, with some user interaction for verification (Did “Cobalt” bring you here? Yes/No)

e. Has a default domain if no default subdomain is present (Generic FlyingPlaza)

f. Allows “locking” to a vendor for a defined period of time when out of bounds of the geofence.

g. Allows “locking” to vendor when no immediate overlaps are present (grows the radius automatically)

Capable of Switching from AirBox to Cloud

a. Only guidelines will be provided to assist the AirBox product and the Cloud website

b. Mostly requires the multi-vendor systems online to react to subdomains (one per vendor per location)

c. Can list known IPs for querying AirBox servers (if DNS cannot resolve to AirBox)

Supports Native Video Streaming

a. App reacts to native format of video player, allowing OS to take over video player to ensure smooth play, full screen view and OS dependent UI and controls

b. Capable of streaming video content with dynamic buffering

c. Capable of requesting alternative quality of data streams

d. May not be capable of automatically selecting alternative video streams (if a library is found that can do this, we will use it, otherwise excluded)

e. Capable of playing play DASH, SmoothStreaming and HLS adaptive streams, as well as formats such as MP4, M4A, FMP4, WebM, MKV, MP3, Ogg, WAV, MPEG-TS, MPEG-PS, FLV and ADTS (AAC) on Android

Compliant with DRM Delivery of Video

Can be Built Open Without Rrework

a. This means that as new functionality comes in, extra effort and costs won't be incurred due to a modular architecture approach

Integrate Content from Flying Plaza Web Site

a. This include single sign on

b. E-commerce platform functionality including
i. Cart
ii. Ordering
iii. Billing

Common Module that Will Always be Available to the Users

a. Passenger profile

b. Profiling all passengers

c. Intersize converter

d. Currency Converter

e. Reward Points

f. Offers & Events

g. Wish List & Gift List

h. Feedback

Pre-Flight Modules Include the Following Functionality

a. Landing Page

b. Special Offers

c. Book a flight

d. Payment

e. Seat Selection

f. Flight Status Map

g. Flight Status

h. VIP Lounge

Duty Free shopping will allow the user to have vouchers, access to different services and rating of experience.

Post-Flight Modules will Allow a Seamless Transformation with the Following Possible Modules

a. In-App Ticketing

b. Local Vouchers

c. Local Services

d. VIP Lounge

e. Places to see

f. Things to do Content

g. Rate your journey

h. Rate your experience

Shopping as Content Providing this Includes

a. Local Vouchers

b. Things to do Content

c. Rate your experience

Web Portal for Administration (Mostly for Transformer Related Capabilities)

a. Has an administrator login, but no self-registration

b. User management (create, edit, delete users)

c . Can reset password (self and from admin)

d. Only has 1 role

e. Access to all modules without permissions

f. Is mobile first and responsive to all screen sizes

g. UI and UX dictated by Exelia with only choices in pre-development from Exelia made templates

h. Targets only MiniMe-Labs users

i. Vendor management (Only supports very basic adding of vendors and their location)

j. Can create vendors and assign a vendor id

k. Can create vendor locations and assign a subdomain to each one

l. Allows reuse of subdomains across multiple locations

m. Can pinpoint a geolocation for a vendor location (longitude and latitude)

n. Can adjust the radius of each vendor location

o. Specify vendor logo in different sizes as required by the app

p. Specify vendor assets with upload functionality

q. Specify vendor branding, styling, colors for foreground, background and text

r. Can specify offline vendors that require the app to pre-load the styles and logos (i.e. for Flights)

Goals and Business Objectives

The Flying Plaza Transformer App will be an app that changes and transforms into participating vendor's branding seamlessly. It will be built in a modular fashion that will support scalability and ability to adapt into different transformative content provisions, by means of a layered plug and play approach.

The business objective is that the app will be downloaded once but to be used across various vendors and service many industries by means of its transformer capabilities that will be implemented via automatic content providers recognition. The geolocation module of the app permits vendor identification allowing content providers specific interaction to occur with the consumer.

The AI will learn the cognitive behavior of the consumer by applying a broad set of methods and algorithms in order to provide user specific suggestions and recommendations.

Modules of the App: The app is modular as to ensure scalability and flexibility in providing the transformer capability to the user. The approach is to build the transformer app using modules, that will be available to the user dynamically depending on the location and journey status the user is.

There are three main stakeholders in the full spectrum of the app. The user, Flying Plaza and the content providers. The content providers consist out of retailers, travel content providers, that can include travel agencies, hotel and resorts, entertainment providers and more. It can also include advertisers. Another major provider of options to the user experience will be shopping malls, called parent providers and the stores inside, called child provers. However, this relationship will not form part of this scope. (see exclusions) The diagram provides a high-level overview of the journey with functionality and architecture.

The first part of the functionality will be the downloading of the app as first entry point to the journey. This can be done from any of the content providers depending on the first provider that will offer the installation of the white labeled app. This is called the originator. Once the app is installed it will be linked to a tiered platform/backend. The backend will consist out of the following tiers:

Modules

These are based on the content providers available in the location radius of the user

These modules will be provided by admin of Flying plaza for the scope of this document. In future versions of the app, this will be populated by content providers through an interface onthe platform of Flying plaza, allowing for on demand provision of content as well as opportunity to target specific groups of users.

These will be predefined modules that are related to the transformative nature of the app

Artificial Intelligence layer (AI)

This is a unique layer that provides suggestions and recommendations to users based on preferences, trends and user history data.

Flying Plaza main platform

The main platform of flying plaza will include the big data, AI and business intelligence that will provide the bridge between the content providers and the user

The platform will be on the cloud, but will also push offline content to the user when the user is on line that can be used when the user is offline. It also communicates with the airbox if one is available.

Content providers

These include all providers that assists in the users' journey from preflight till post flight. Given the user a holistic seamless experience.

These can include airlines, travel agencies, hotels, resort, transportation providers, duty free, malls, retailers, entertainment providers etc.

Each of the tiers will be providing content depending on where the user is in the journey path. The table indicates the suggested modules mapped to the journey position of the user. The app will have a set of preloaded modules that will always be part of the app. All modules will not necessary be available, and will depend on the content availability in the areas where the user is at that point in time.

Download and installation: The seamless transforming of the app to adapt to the user's location or “journey” needs to be unique for each user. The user journey starts with the downloading of the app as first entry point to the journey, depending on the first provider that will offer the installation of the white labeled app. This is called the originator. If no geo location is available this will be the provider that will supply the modular data for the user experience.

During the installation process the user, will create a profile that will provide information to the AI engine of Flying Plaza, as to ensure the customer is experiencing all interactions on an individual base.

During installation the user will be requested to give access to location ad notifications. If the user chooses not to have location turned on, the app will rely on the user to search by location as to offer the transformation of the app to adapt to the user's journey path. If the user does tum on the notification, alerts will allow the user to have the most updated experience and assistance from the app for a better in app experience.

Once the app is installed the user login is created and the user will be able to start the full transformation experience, based on the journey path.

### BRIEF DESCRIPTION OF THE DRAWINGS

The present subject matter will now be described in detail with reference to the drawings, which are provided as illustrative examples of the subject matter so as to enable those skilled in the art to practice the subject matter. Notably, the FIGUREs and examples are not meant to limit the scope of the present subject matter to a single embodiment, but other embodiments are possible by way of interchange of some or all of the described or illustrated elements and, further, wherein:

FIG. 1 is view of a set of tablet computing devices operating the instructions, generating and storing in a non-transitory computer memory the data and executable instructions of the present disclosure;

FIG. 2 is view of a flying plaza user journey as may be applicable to the teachings of the present disclosure;

FIG. 3 is view of the applicable module layers for the functions and features of the presently disclosed subject matter;

FIG. 4 graphically depicts and relationships of an exemplary embodiment of the subject matter of the present disclosure;

FIG. 5 shows the respective module descriptions as applicable to the presently disclosed subject matter;

FIG. 6 presents the association of a user journey, status, interaction, and information applicable to an exemplary embodiment of the presently disclosed subject matter; and

FIGS. 7 through 22 show various stages of an exemplary use case of the presently disclosed methods and systems.

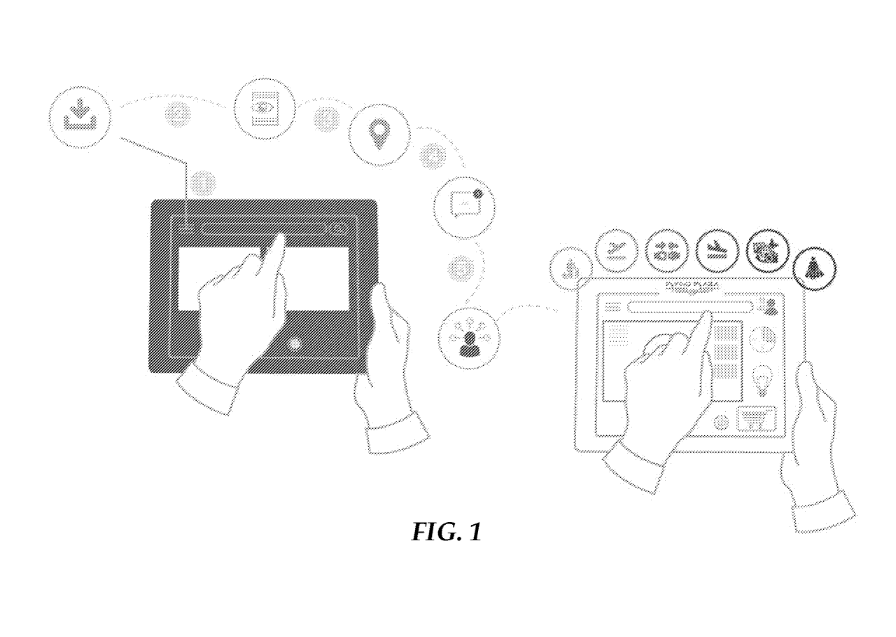

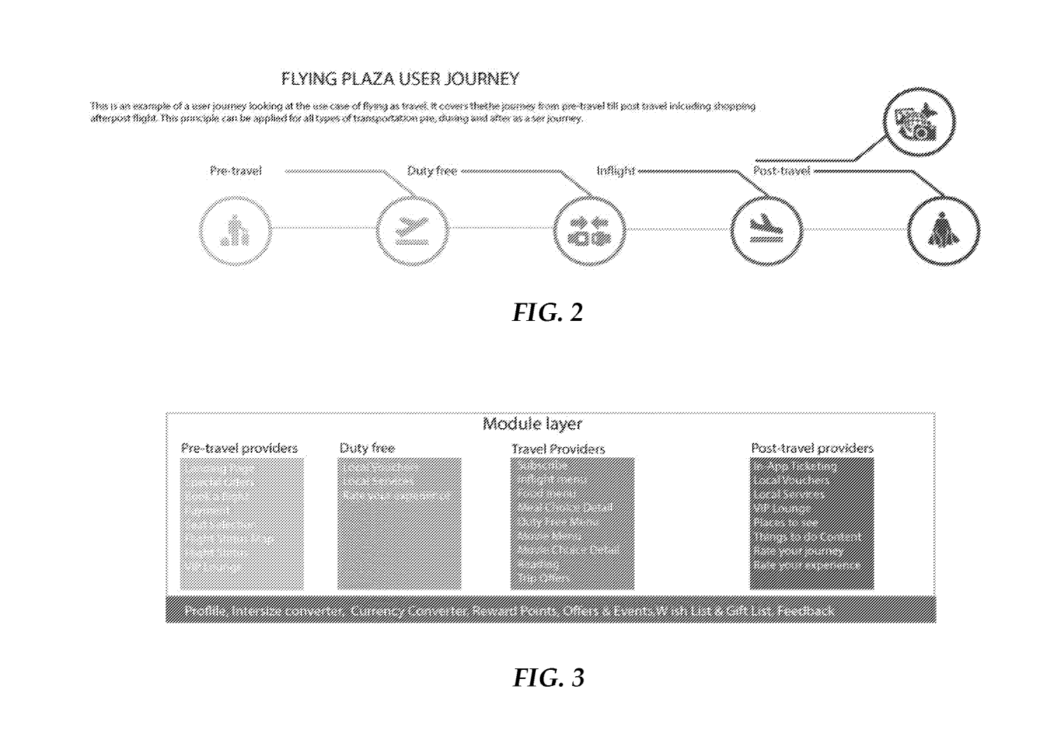

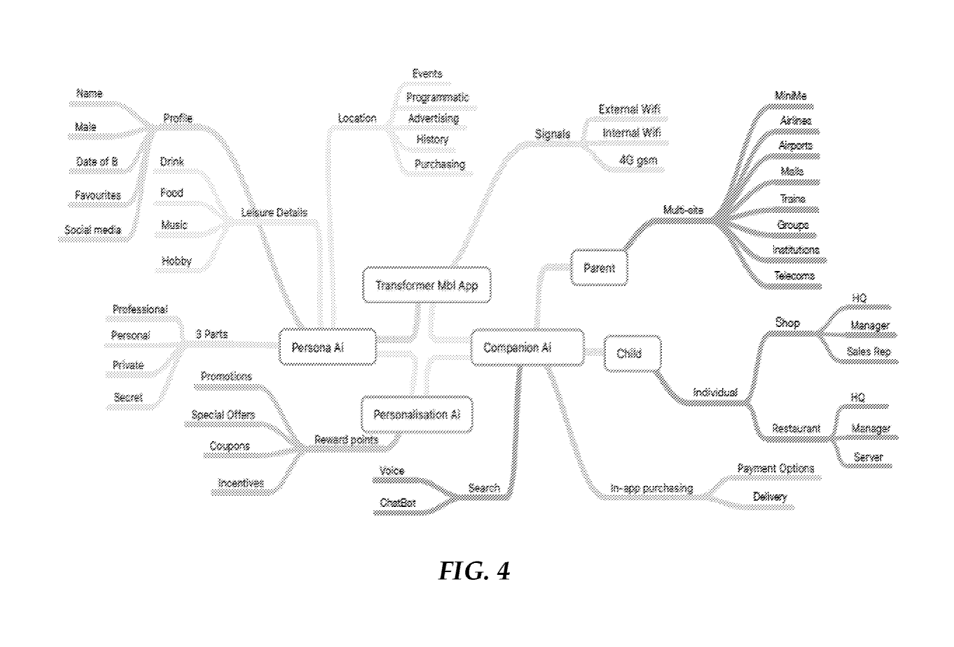

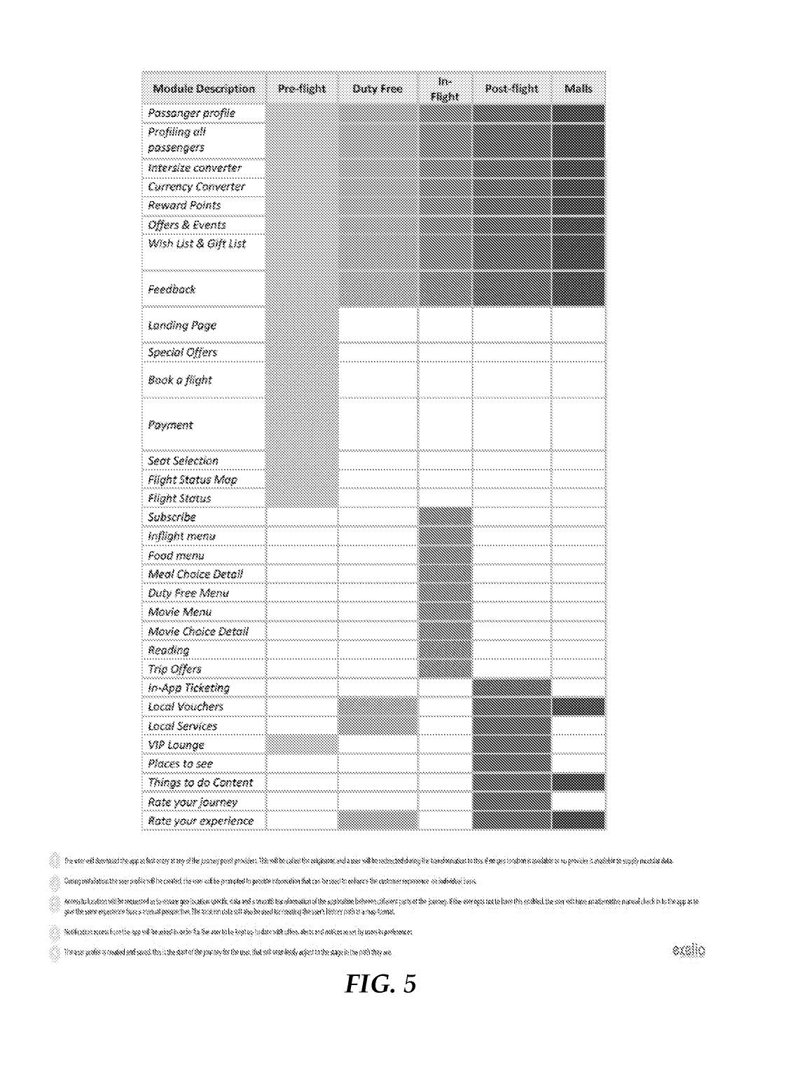

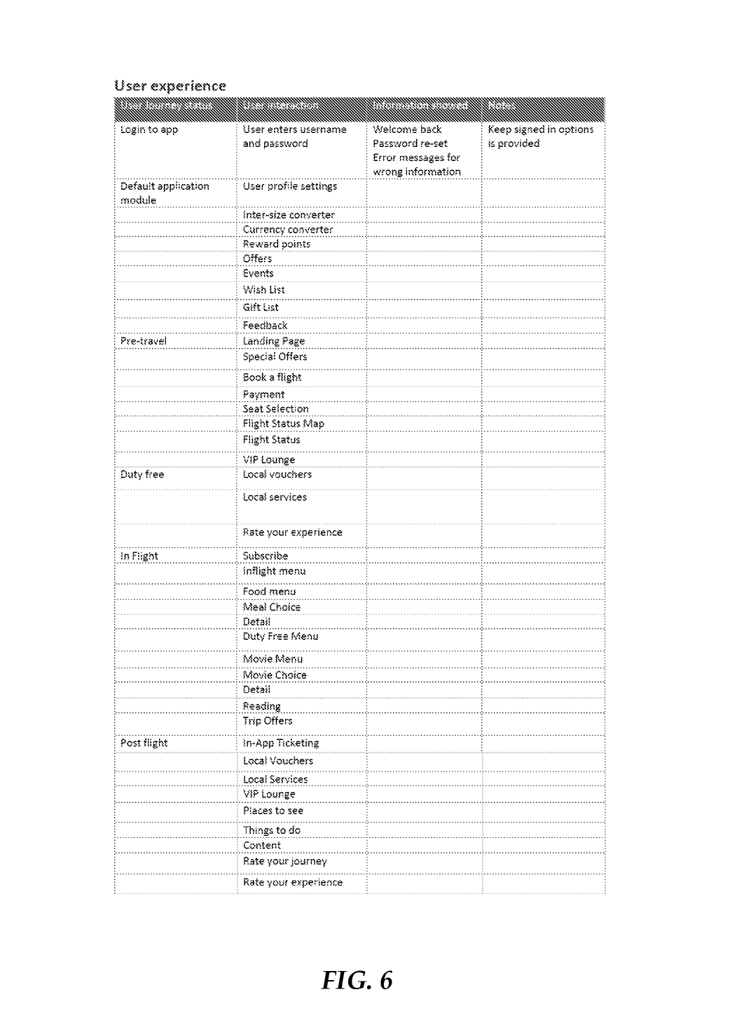

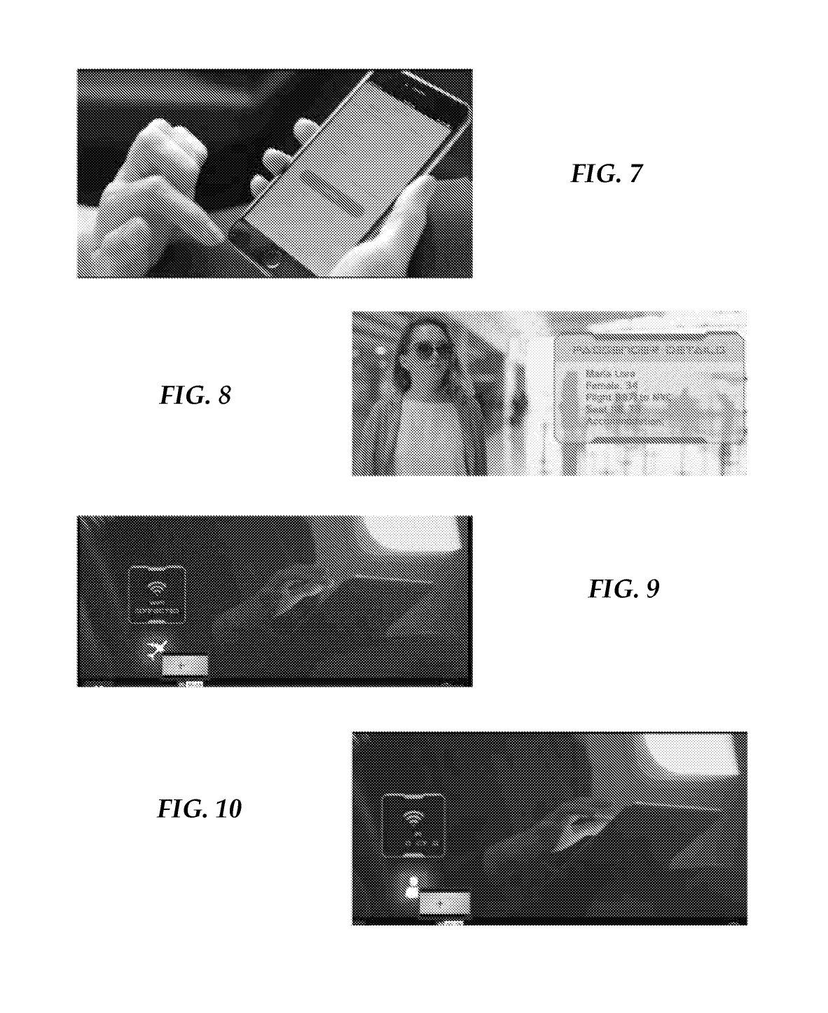

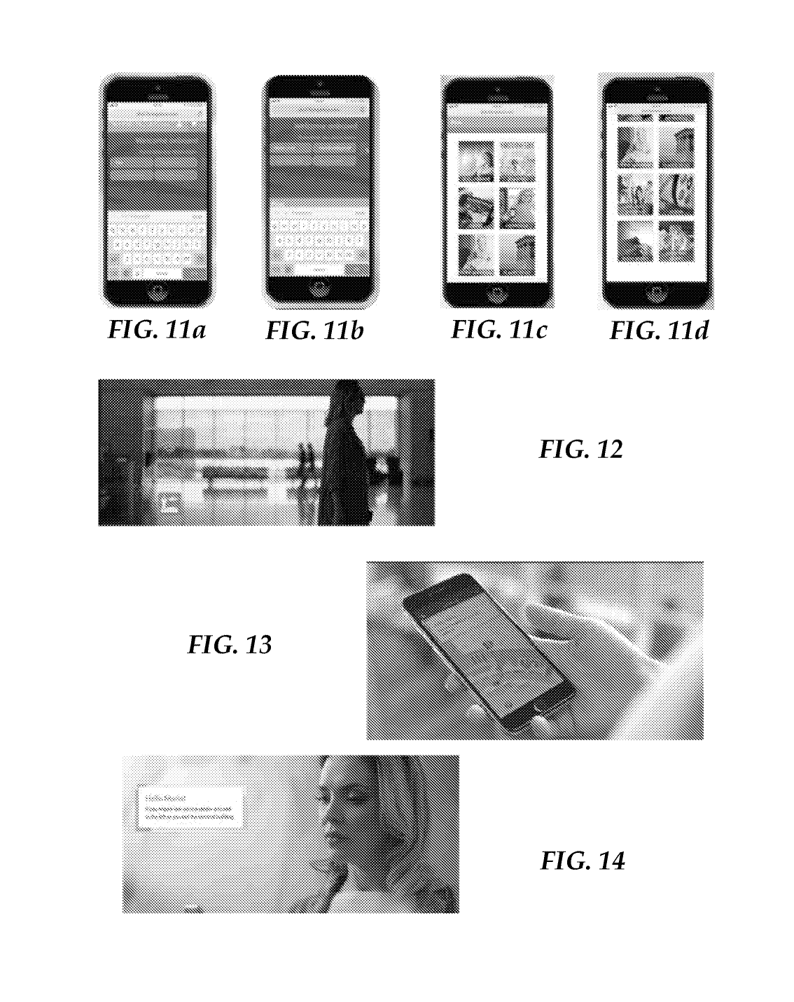

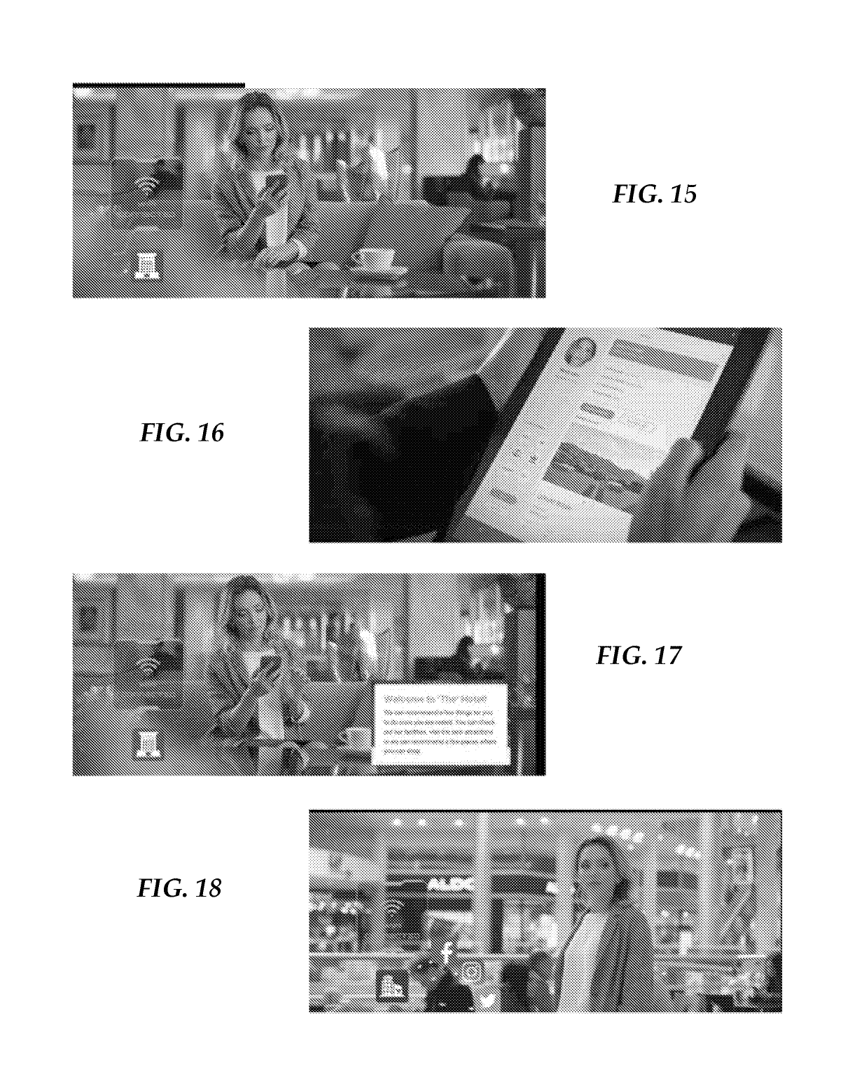

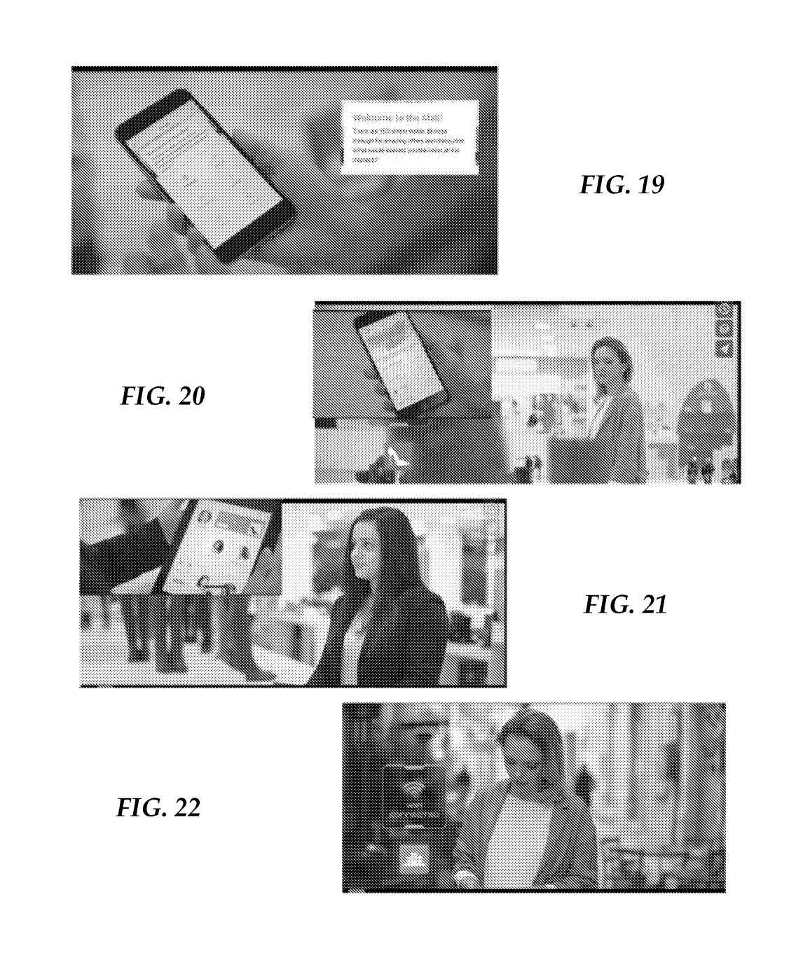

The detailed description set forth in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

In the present specification, an embodiment showing a singular component should not be considered limiting. Rather, the subject matter preferably encompasses other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present subject matter encompasses present and future known equivalents to the known components referred to herein by way of illustration.

The detailed description set forth herein in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments.

This detailed description of illustrative embodiments includes specific details for providing a thorough understanding of the presently disclosed subject matter. However, it will be apparent to those skilled in the art that the presently disclosed subject matter may be practiced without these specific details. In some instances, well-known structures and devices are shown in block diagram form in order to avoid obscuring the concepts of the presently disclosed method and system.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein, but is to be accorded the widest scope consistent with the principles and novel features disclosed herein. It is contemplated that additional embodiments are within the spirit and true scope of the disclosed subject matter.

We claim:

1. A methods for providing a location-based, single user-centric application for all customer experienced application data, comprising:
a transformative application, offering adaptive content, based on location, vendor, personal data and cross channel information, comprising a move away from a narrow-focused application into a personalized application that will offer increased functionality offering targeted, incremental, timed communication with the user and/or application;
said application based on intelligence of the application that keeps learning from big data that is scaled into focused data, wherein big data will be gathered from implicit, explicit as well as location and environment data feeds related to pre-action, action and post action from the user; and
further comprising subconscious actions while using the application.
